(19) United States
(12) Patent Application Publication
(10) Pub. No.: US 2016/0196894 A1
(43) Pub. Date: Jul. 7, 2016

(54) LAMINATE AND TRANSPARENT CONDUCTIVE FILM USING THE LAMINATE

(71) Applicant: NITTO DENKO CORPORATION, Ibaraki-shi, Osaka (JP)

(72) Inventors: Shouichi Matsuda, Ibaraki-shi (JP); Ayami Nakato, Ibaraki-shi (JP); Hiroyuki Takemoto, Ibaraki-shi (JP)

(73) Assignee: NITTO DENKO CORPORATION, Ibaraki-shi, Osaka (JP)

(21) Appl. No.: 14/649,016

(22) PCT Filed: Dec. 5, 2013
(86) PCT No.: PCT/JP2013/082673

§ 371 Date: Jun. 2, 2015

(30) Foreign Application Priority Data
Dec. 6, 2012 (JP) 2012-267517

(51) Int. Cl. H01B 3/30; H01B 3/44

(52) U.S. Cl. CPC H01B 3/307; H01B 3/447

(57) ABSTRACT

There is provided a laminate excellent in dimensional stability under high temperature and high humidity despite the fact that the laminate includes resin films.

A laminate according to an embodiment of the present invention includes a plurality of resin films with hard coat layers, which are laminated together, the plurality of resin films with hard coat layers each including a base layer containing a thermoplastic resin and a hard coat layer containing a curable resin, the hard coat layer being formed on the base layer.

### TECHNICAL FIELD

The present invention relates to a laminate and a transparent conductive film using the laminate.

### BACKGROUND ART

A resin film has heretofore been used as a substrate for, for example, an electrode for a touch panel or the like, or an electromagnetic wave shield for blocking an electromagnetic wave responsible for the malfunction of an electronic device. The resin film generally has the following features. The resin film is excellent in impact resistance, is lightweight, and is excellent in flexibility. Accordingly, the resin film can contribute to the weight reduction and thinning of an electronic device. However, on the other hand, the resin film has low dimensional stability. Changes in dimensions of the resin film become remarkable particularly under high temperature and high humidity. Accordingly, there occurs such a problem that a condition, under which the resin film is processed, is restrained. In addition, the dimensions of the resin film incorporated into a product (such as an electronic device) may change at the time of the use of the product, and hence there occurs such a problem that a condition, under which the resin film is used, is restrained.

### CITATION LIST

### Patent Literature

[PTL 1] JP 2008-107510 A

### SUMMARY OF INVENTION

### Technical Problem

The present invention has been made to solve the problems, and an object of the present invention is to provide a laminate excellent in dimensional stability under high temperature and high humidity despite the fact that the laminate includes resin films.

### Solution to Problem

A laminate according to an embodiment of the present invention includes a plurality of resin films with hard coat layers, which are laminated together, the plurality of resin films with hard coat layers each including a base layer containing a thermoplastic resin and a hard coat layer containing a curable resin, the hard coat layer being formed on the base layer.

In one embodiment of the present invention, the laminate has a lamination construction vertically symmetric with respect to a center line in a thickness direction thereof.

In one embodiment of the present invention, a number of the resin films with hard coat layers is two.

In one embodiment of the present invention, the plurality of resin films with hard coat layers are bonded to each other through an adhesive layer or a pressure-sensitive adhesive layer.

In one embodiment of the present invention, the respective base layers of the two resin films with hard coat layers are bonded to each other through the adhesive layer or the pressure-sensitive adhesive layer.

In one embodiment of the present invention, the respective hard coat layers of the two resin films with hard coat layers are bonded to each other through the adhesive layer or the pressure-sensitive adhesive layer.

In one embodiment of the present invention, the laminate comprises the two resin films with hard coat layers; and the base layer of one of the resin films with hard coat layers and the hard coat layer of another of the resin films with hard coat layers are bonded to each other through the adhesive layer or the pressure-sensitive adhesive layer.

In one embodiment of the present invention, the laminate has a total light transmittance of 80% or more.

In one embodiment of the present invention, the thermoplastic resin in the base layer comprises a (meth)acrylic resin.

According to another aspect of the present invention, there is provided a transparent conductive film. The transparent conductive film includes the laminate and a transparent conductive layer formed on the laminate.

In one embodiment of the present invention, the transparent conductive layer contains a metal nanowire.

In one embodiment of the present invention, the transparent conductive layer contains a metal mesh.

In one embodiment of the present invention, the transparent conductive layer contains a polythiophene-based polymer.

### Advantageous Effects of Invention

According to the present invention, the plurality of resin films with hard coat layers each having a hard coat layer formed on a resin layer are laminated, and hence the laminate excellent in dimensional stability under high temperature and high humidity can be provided.

### BRIEF DESCRIPTION OF DRAWINGS

FIG. 1 is a schematic sectional view of a laminate according to a preferred embodiment of the present invention.

FIG. 2 is a schematic view of a laminate according to another preferred embodiment of the present invention.

FIG. 3 is a schematic sectional view of a laminate according to still another preferred embodiment of the present invention.

### DESCRIPTION OF EMBODIMENTS

A. Entire Construction of Laminate

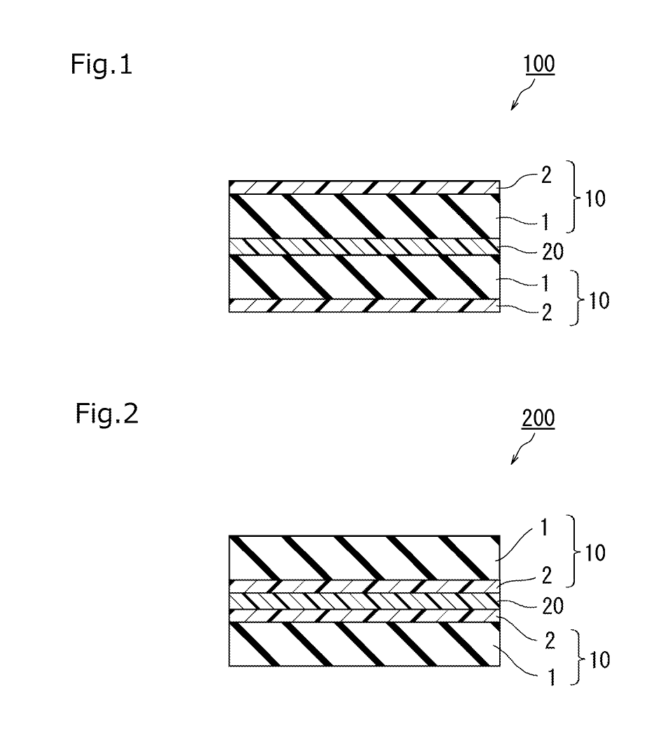

FIG. 1 is a schematic sectional view of a laminate according to a preferred embodiment of the present invention. A laminate 100 includes a plurality of (two in the illustrated example) resin films 10 with hard coat layers, which are laminated together. The resin films 10 with hard coat layers each include a base layer 1 containing a thermoplastic resin and a hard coat layer 2 formed on the base layer 1. The hard coat layer 2 contains a curable resin. The two resin films 10 with hard coat layers are preferably bonded to each other through an adhesive layer 20. In the embodiment illustrated in FIG. 1, the respective base layers 1 of the two resin films 10 with hard coat layers (i.e., the base layer 1 of one of the resin films 10 with hard coat layers and the base layer 1 of the other resin film 10 with a hard coat layer) are bonded to each other through the adhesive layer 20. It should be noted that the following may be adopted: a pressure-sensitive adhesive layer is placed instead of the adhesive layer 20, and the two resin films 10 with hard coat layers are bonded to each other through the pressure-sensitive adhesive layer.

FIG. 2 is a schematic view of a laminate according to another preferred embodiment of the present invention. In a laminate 200, the respective hard coat layers 2 of the two resin films 10 with hard coat layers (i.e., the hard coat layer 2 of one of the resin films 10 with hard coat layers and the hard coat layer 2 of the other resin film 10 with a hard coat layer) are bonded to each other through an adhesive layer 20.

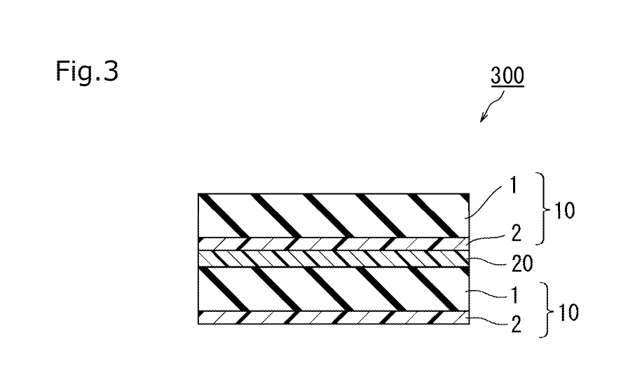

FIG. 3 is a schematic sectional view of a laminate according to still another preferred embodiment of the present invention. In a laminate 300, the base layer 1 of one of the resin films 10 with hard coat layers and the hard coat layer 2 of the other resin film 10 with a hard coat layer are bonded to each other through the adhesive layer 20.

FIGS. 1 to 3 each illustrate a laminate including the two resin films 10 with hard coat layers, which are laminated together. However, a laminate in which three or more resin films 10 with hard coat layers are laminated may be produced by further laminating the resin film 10 with a hard coat layer. A plurality of resin films with hard coat layers can be bonded to each other through an adhesive layer or a pressure-sensitive adhesive layer. The number of the resin films with hard coat layers is preferably from 2 to 10, more preferably from 2 to 6, still more preferably from 2 to 4. In addition, the number of the resin films with hard coat layers is preferably an even number.

The laminate of the present invention is excellent in dimensional stability under high temperature and high humidity by including a plurality of resin films with hard coat layers as described above. In addition, a laminate having extremely high dimensional stability under high temperature and high humidity can be obtained by placing a plurality of hard coat layers through a base layer, an adhesive layer, or a pressure-sensitive adhesive layer. The dimensional stability of the laminate is much higher than that of a film that has a two-layer construction formed only of a hard coat layer and a base layer (resin layer), and has a thickness comparable to that of the laminate.

It is preferred that the construction of the laminate of the present invention be vertically symmetric with respect to a center line in its thickness direction. The laminate of such construction is, for example, a laminate in which: the two resin films with hard coat layers are placed so as to be vertically symmetric as illustrated in FIG. 1 or 2; the thicknesses and constituent materials of the two base layers are the same; and the thicknesses and constituent materials of the two hard coat layers are the same. A laminate showing small curling (warping) can be obtained by making its construction vertically symmetric with respect to the center line in the thickness direction.

The total light transmittance of the laminate of the present invention is preferably 80% or more, more preferably 85% or more, still more preferably 90% or more. A laminate having a total light transmittance within such range is useful as, for example, a substrate for a transparent electrode or an electromagnetic wave shield.

A dimensional change ratio (area shrinkage ratio) when the resin film with a hard coat layer is placed under 120° C. for 90 minutes is preferably 3% or less, more preferably 2% or less, still more preferably from 0.1% to 1.5%.

A dimensional change ratio (area shrinkage ratio) when the resin film with a hard coat layer is immersed in warm water at 85° C. for 30 minutes is preferably 3% or less, more preferably 2% or less, still more preferably from 0.1% to 1.5%.

B. Resin Film with Hard Coat Layer

As described above, the resin film with a hard coat layer includes the base layer and the hard coat layer.

The thickness of the resin film with a hard coat layer is preferably from 30 μm to 200 μm, more preferably from 40 μm to 180 μm, still more preferably from 45 μm to 160 μm.

B-1. Base Layer

The thickness of the base layer is preferably from 20 μm to 200 μm, more preferably from 30 μm to 150 μm.

The thickness direction retardation and in-plane retardation of the base layer are preferably small. As long as the thickness direction retardation and in-plane retardation of the base layer are small, when the laminate of the present invention is used in an image display apparatus (as, for example, a substrate for an electrode of a touch panel), adverse effects on its display characteristics are reduced. For example, when a laminate including a low-retardation base layer is used by being incorporated into a liquid crystal display, the occurrence of a rainbow-like patchy pattern (hereinafter sometimes referred to as “rainbow patch”) is prevented. Such effect becomes additionally significant when light that passes through the base layer is elliptically polarized light.

The absolute value of a thickness direction retardation Rth of the base layer is 100 nm or less, preferably 75 nm or less, more preferably 50 nm or less, particularly preferably 10 nm or less, most preferably 5 nm or less. It should be noted that the thickness direction retardation Rth as used herein refers to a thickness direction retardation value at 23° C. and a wavelength of 590 nm. The Rth is determined from the equation “Rth=(nx−nz)×d” where nx represents a refractive index in the direction in which an in-plane refractive index becomes maximum (i.e., a slow axis direction), nz represents a thickness direction refractive index, and d (nm) represents the thickness of the base layer.

An in-plane retardation Re of the base layer is preferably 10 nm or less, more preferably 5 nm or less, still more preferably from 0 nm to 2 nm. It should be noted that the in-plane retardation Re as used herein refers to an in-plane retardation value at 23° C. and a wavelength of 590 nm. The Re is determined from the equation “Re=(nx−ny)×d” where nx represents the refractive index in the direction in which the in-plane refractive index becomes maximum (i.e., the slow axis direction), ny represents a refractive index in a direction perpendicular to the slow axis in a plane (i.e., a fast axis direction), and d (nm) represents the thickness of the base layer.

The total light transmittance of the base layer is preferably 80% or more, more preferably 85% or more, still more preferably 90% or more.

The base layer contains a thermoplastic resin. Examples of the thermoplastic resin include: cycloolefin-based resins such as polynorbornene; (meth)acrylic resins; and low-retardation polycarbonate resins. Of those, a cycloolefin-based resin or a (meth)acrylic resin is preferred. The use of such resin can provide a base layer having a small retardation. In addition, such resin is excellent in, for example, transparency, mechanical strength, thermal stability, and moisture barrier property. The thermoplastic resin is more preferably a (meth)acrylic resin. The use of a (meth)acrylic resin can provide a laminate excellent in adhesiveness between its base layer and hard coat layer, and having additionally high dimensional stability. One kind of the thermoplastic resins may be used alone, or two or more kinds thereof may be used in combination.

The polynorbornene refers to a polymer or copolymer obtained by using a norbornene-based monomer having a norbornene ring as part or the entirety of starting raw materials (monomers). Examples of the norbornene-based monomer include: norbornene and an alkyl and/or alkylidene substitution product thereof such as 5-methyl-2-norbornene, 5-dimethyl-2-norbornene, 5-ethyl-2-norbornene, 5-butyl-2-norbornene, or 5-ethylidene-2-norbornene, and a substitution product thereof with a polar group such as a halogen; dicyclopentadiene; 2,3-dihydrodicyclopentadiene; and dimethanooctahydronaphthalene, an alkyl and/or alkylidene substitution product thereof, and a substitution product thereof with a polar group such as a halogen, and a trimer and tetramer of cyclopentadiene such as 4,9:5,8-dimethano-3a,4,4a,5,8,8a,9,9a-octahydro-1H-benzoindene and 4,11:5,10:6,9-trimethano-3a,4,4a,5,5a,6,9,9a,10,10a,11,11a-dodecahydro-1H-cyclopentaanthracene.

Various products are commercially available as the polynorbornene. Specific examples thereof include: products available under the trade names “ZEONEX” and “ZEONOR” from neon Corporation; a product available under the trade name “Arton” from JSR Corporation; a product available under the trade name “TOPAS” from TICONA; and a product available under the trade name “APEL” from Mitsui Chemicals, Inc.

The (meth)acrylic resin refers to a resin having a repeating unit derived from a (meth)acrylate ((meth)acrylate unit) and/or a repeating unit derived from (meth)acrylic acid ((meth)acrylic acid unit). The (meth)acrylic resin may have a constituent unit derived from a derivative of a (meth)acrylate or (meth)acrylic acid.

In the (meth)acrylic resin, the total content of the (meth)acrylate unit, the (meth)acrylic acid unit, and the constituent unit derived from a derivative of a (meth)acrylate or (meth)acrylic acid is preferably 50 wt % or more, more preferably from 60 wt % to 100 wt %, particularly preferably from 70 wt % to 90 wt % with respect to all constituent units constituting the acrylic resin. When the total content falls within such range, a base layer having a low retardation can be obtained.

The (meth)acrylic resin may have a ring structure on its main chain. The presence of the ring structure can increase the glass transition temperature of the (meth)acrylic resin while suppressing an increase in its retardation. Examples of the ring structure include a lactone ring structure, a glutaric anhydride structure, a glutarimide structure, an N-substituted maleimide structure, and a maleic anhydride structure.

The lactone ring structure can adopt any appropriate structure. The lactone ring structure is preferably a four- to eight-membered ring, more preferably a five-membered ring or a six-membered ring, still more preferably a six-membered ring. A six-membered lactone ring structure is, for example, a lactone ring structure represented by the following general formula (1).

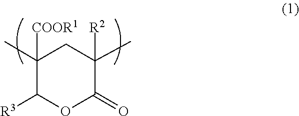

In the general formula (1), R¹, R², and R³ each independently represent a hydrogen atom, a linear or branched alkyl group having 1 to 20 carbon atoms, an unsaturated aliphatic hydrocarbon group having 1 to 20 carbon atoms, or an aromatic hydrocarbon group having 1 to 20 carbon atoms. The alkyl group, the unsaturated aliphatic hydrocarbon group, and the aromatic hydrocarbon group may each have a substituent such as a hydroxyl group, a carboxyl group, an ether group, or an ester group.

The glutaric anhydride structure is, for example, a glutaric anhydride structure represented by the following general formula (2). The glutaric anhydride structure can be obtained by, for example, subjecting a copolymer of a (meth)acrylate and (meth)acrylic acid to intramolecular dealcoholization cyclization condensation.

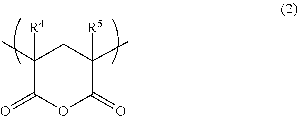

In the general formula (2), R⁴ and R⁵ each independently represent a hydrogen atom or a methyl group.

The glutarimide structure is, for example, a glutarimide structure represented by the following general formula (3). The glutarimide structure can be obtained by, for example, imidizing a (meth)acrylate polymer with an imidizing agent such as methylamine.

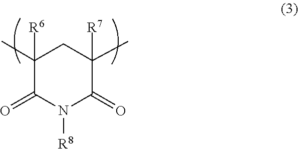

In the general formula (3), R⁶ and R⁷ each independently represent a hydrogen atom, or a linear or branched alkyl group having 1 to 8 carbon atoms, preferably a hydrogen atom or a methyl group. R⁸ represents a hydrogen atom, a linear alkyl group having 1 to 18 carbon atoms, a cycloalkyl group having 3 to 12 carbon atoms, or an aryl group having 6 to 10 carbon atoms, preferably a linear alkyl group having 1 to 6 carbon atoms, a cyclopentyl group, a cyclohexyl group, or a phenyl group.

In one embodiment, the (meth)acrylic resin has a glutarimide structure represented by the following general formula (4) and a methyl methacrylate unit.

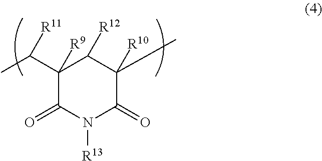

In the general formula (4), R⁹ to R¹² each independently represent a hydrogen atom, or a linear or branched alkyl group having 1 to 8 carbon atoms. R¹³ represents a linear or branched alkyl group having 1 to 18 carbon atoms, a cycloalkyl group having 3 to 12 carbon atoms, or an aryl group having 6 to 10 carbon atoms.

The N-substituted maleimide structure is, for example, an N-substituted maleimide structure represented by the following general formula (5). A (meth)acrylic resin having the N-substituted maleimide structure on its main chain can be obtained by, for example, copolymerizing an N-substituted maleimide and a (meth)acrylate.

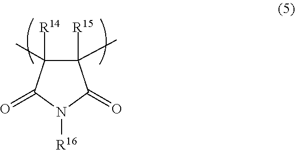

In the general formula (5), R¹⁴ and R¹⁵ each independently represent a hydrogen atom or a methyl group, and R¹⁶ represents a hydrogen atom, a linear alkyl group having 1 to 6 carbon atoms, a cyclopentyl group, a cyclohexyl group, or a phenyl group.

The maleic anhydride structure is, for example, a maleic anhydride structure represented by the following general formula (6). A (meth)acrylic resin having the maleic anhydride structure on its main chain can be obtained by, for example, copolymerizing maleic anhydride and a (meth)acrylate.

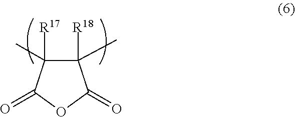

In the general formula (6), R¹⁷ and R¹⁸ each independently represent a hydrogen atom or a methyl group.

The (meth)acrylic resin may have any other constituent unit. Examples of the other constituent unit include constituent units derived from monomers such as styrene, vinyltoluene, a-methylstyrene, acrylonitrile, methyl vinyl ketone, ethylene, propylene, vinyl acetate, methallyl alcohol, allyl alcohol, 2-hydroxymethyl-1-butene, a-hydroxymethylstyrene, α-hydroxyethylstyrene, a 2-(hydroxyalkyl)acrylate such as methyl 2-(hydroxyethyl) acrylate, and a 2-(hydroxyalkyl) acrylic acid such as 2-(hydroxyethyl)acrylic acid.

In addition to the (meth)acrylic resins exemplified above, specific examples of the (meth)acrylic resin also include (meth)acrylic resins disclosed in JP 2004-168882 A, JP 2007-261265 A, JP2007-262399A, JP2007-297615A, JP2009-039935A, JP2009-052021 A, and JP 2010-284840 A.

The glass transition temperature of the material constituting the base layer is preferably from 100° C. to 200° C., more preferably from 110° C. to 150° C., particularly preferably from 110° C. to 140° C. When the glass transition temperature falls within such range, a laminate excellent in heat resistance and excellent in dimensional stability at high temperature can be obtained.

The base layer may further contain any appropriate additive as required. Specific examples of the additive include a plasticizer, a heat stabilizer, a light stabilizer, a lubricant, an antioxidant, a UV absorber, a flame retardant, a coloring agent, an antistatic agent, a compatibilizer, a cross-linking agent, and a thickener. The kind and amount of the additive to be used may be appropriately set depending on purposes.

Any appropriate molding method is employed as a method of obtaining the base layer, and a proper method can be appropriately selected from, for example, a compression molding method, a transfer molding method, an injection molding method, an extrusion molding method, a blow molding method, a powder molding method, a FRP molding method, and a solvent casting method. Of those production methods, an extrusion molding method or a solvent casting method is preferably employed. This is because the smoothness of the base layer to be obtained is improved and hence good optical uniformity can be obtained. Molding conditions can be appropriately set depending on, for example, the composition and kind of the resin to be used.

The base layer may be subjected to various surface treatments as required. Any appropriate method is adopted for such surface treatment depending on purposes. Examples thereof include a low-pressure plasma treatment, an ultraviolet irradiation treatment, a corona treatment, a flame treatment, and acid and alkali treatments. In one embodiment, the surface of the base layer is hydrophilized by subjecting the base layer to a surface treatment. When the base layer is hydrophilized, processability upon application of a composition for forming a transparent conductive layer (described later) prepared with an aqueous solvent becomes excellent. In addition, a laminate excellent in adhesiveness between the base layer and the hard coat layer, and adhesiveness between the base layer and a transparent conductive layer (described later) can be obtained.

B-2. Hard Coat Layer

In the present invention, the hard coat layer has a function of imparting chemical resistance, scratch resistance, and surface smoothness to the laminate. In addition, the layer has a function of improving the dimensional stability of the laminate under high temperature and high humidity. In a laminate excellent in dimensional stability, the characteristics of the base layer hardly deteriorate even under high temperature and high humidity; for example, an increase in retardation of the base layer is prevented.

The thickness of the hard coat layer is preferably from 1 μm to 50 μm, more preferably from 2 μm to 40 μm, still more preferably from 3 μm to 30 μm. When the thickness of the hard coat layer falls within such range, a laminate additionally excellent in dimensional stability and having a small retardation can be obtained.

The modulus of elasticity in tension of the hard coat layer at 25° C. is preferably from 2.5 GPa to 20 GPa, more preferably from 3 GPa to 15 GPa, still more preferably from 3.5 GPa to 10 GPa. When the modulus of elasticity in tension of the hard coat layer falls within such range, a laminate excellent in dimensional stability can be obtained. It should be noted that the modulus of elasticity in tension can be measured in conformity with JIS K7161.

The coefficient of linear thermal expansion of the hard coat layer at from 50° C. to 250° C. is preferably from 0/° C. to 100×10⁻⁶/° C., more preferably from 0/° C. to 50×10⁻⁶/° C. When the coefficient of linear thermal expansion of the hard coat layer falls within such range, a laminate excellent in dimensional stability under high temperature can be obtained. It should be noted that the coefficient of linear thermal expansion of the hard coat layer is preferably higher than the coefficient of linear thermal expansion of the base layer.

The water absorption ratio of the hard coat layer is preferably from 0% to 1%, more preferably from 0% to 0.5%. When the water absorption ratio of the hard coat layer falls within such range, a laminate excellent in dimensional stability under high humidity can be obtained. It should be noted that the water absorption ratio can be measured in conformity with JIS K7209.

The hard coat layer contains a curable resin. For example, an acrylic resin, an epoxy-based resin, or a silicone-based resin, or a mixture thereof is used as a material constituting the hard coat layer.

The glass transition temperature of the resin constituting the hard coat layer is preferably from 120° C. to 300° C., more preferably from 130° C. to 250° C. When the glass transition temperature falls within such range, a laminate excellent in dimensional stability under high temperature can be obtained. It should be noted that the glass transition temperature can be measured in conformity with JIS K6240-01.

The hard coat layer is formed by applying a composition for forming a hard coat layer onto the base layer and then curing the composition.

The composition for forming a hard coat layer preferably contains, as a curable compound serving as a main component, a polyfunctional monomer, an oligomer derived from a polyfunctional monomer, and/or a prepolymer derived from a polyfunctional monomer. Examples of the polyfunctional monomer include tricyclodecanedimethanol diacrylate, pentaerythritol di(meth)acrylate, pentaerythritol tri(meth)acrylate, trimethylolpropane triacrylate, pentaerythritol tetra(meth)acrylate, dimethylolpropane tetraacrylate, dipentaerythritol hexa(meth)acrylate, 1,6-hexanediol (meth)acrylate, 1,9-nonanediol diacrylate, 1,10-decanediol (meth)acrylate, polyethylene glycol di(meth)acrylate, polypropylene glycol di(meth)acrylate, dipropylene glycol diacrylate, isocyanuric acid tri(meth)acrylate, ethoxylated glycerin triacrylate, and ethoxylated pentaerythritol tetraacrylate. The polyfunctional monomers may be used alone or in combination.

The polyfunctional monomer preferably has a hydroxyl group. The use of the composition for forming a hard coat layer containing the polyfunctional monomer having a hydroxyl group improves adhesiveness between the base layer and the hard coat layer, and hence can provide a laminate excellent in dimensional stability. In addition, the use can provide a laminate excellent in adhesiveness with the transparent conductive layer (described later). Examples of the polyfunctional monomer having a hydroxyl group include pentaerythritol tri(meth)acrylate and dipentaerythritol pentaacrylate.

The content of the polyfunctional monomer, the oligomer derived from a polyfunctional monomer, and the prepolymer derived from a polyfunctional monomer is preferably from 30 wt % to 100 wt %, more preferably from 40 wt % to 95 wt %, particularly preferably from 50 wt % to 95 wt % with respect to the total amount of the monomer, oligomer, and prepolymer in the composition for forming a hard coat layer. When the content falls within such range, the adhesiveness between the base layer and the hard coat layer improves, and hence a laminate excellent in dimensional stability can be obtained. In addition, the shrinkage on curing of the hard coat layer can be effectively prevented.

The composition for forming a hard coat layer may contain a monofunctional monomer. When the composition for forming a hard coat layer contains the monofunctional monomer, part of the composition permeates the base layer, and hence can improve the adhesiveness between the base layer and the hard coat layer. When the composition for forming a hard coat layer contains the monofunctional monomer, the content of the monofunctional monomer is preferably 40 wt % or less, more preferably 20 wt % or less with respect to the total amount of the monomer, oligomer, and prepolymer in the composition for forming a hard coat layer. When the content of the monofunctional monomer is more than 40 wt %, desired hardness and desired scratch resistance may not be obtained.

The weight-average molecular weight of the monofunctional monomer is preferably 500 or less. Examples of such monofunctional monomer include ethoxylated o-phenylphenol (meth)acrylate, methoxy polyethylene glycol (meth)acrylate, phenoxy polyethylene glycol (meth)acrylate, 2-ethylhexylacrylate, laurylacrylate, isooctylacrylate, isostearylacrylate, cyclohexyl acrylate, isobornylacrylate, benzylacrylate, 2-hydroxy-3-phenoxy acrylate, acryloylmorpholine, 2-hydroxyethyl (meth)acrylate, 4-hydroxybutyl (meth)acrylate, and hydroxyethylacrylamide.

The monofunctional monomer preferably has a hydroxyl group. The use of the composition for forming a hard coat layer containing the monofunctional monomer having a hydroxyl group improves the adhesiveness between the base layer and the hard coat layer, and hence can provide a laminate excellent in dimensional stability. In addition, the use can provide a laminate excellent in adhesiveness with the transparent conductive layer (described later). Examples of the monofunctional monomer having a hydroxyl group include: hydroxyalkyl (meth)acrylates such as 2-hydroxyethyl (meth)acrylate, 2-hydroxypropyl (meth)acrylate, 4-hydroxybutyl (meth)acrylate, 2-hydroxy-3-phenoxy acrylate, and 1,4-cyclohexanemethanol monoacrylate; and N-(2-hydroxyalkyl) (meth)acrylamides such as N-(2-hydroxyethyl) (meth)acrylamide and N-methylol (meth)acrylamide. Of those, 4-hydroxybutyl acrylate and N-(2-hydroxyethyl)acrylamide are preferred.

The composition for forming a hard coat layer may contain a urethane (meth)acrylate and/or an oligomer of the urethane (meth)acrylate. When the composition for forming a hard coat layer contains the urethane (meth)acrylate and/or the oligomer of the urethane (meth)acrylate, a hard coat layer excellent inflexibility and adhesiveness with the base layer can be formed. The urethane (meth)acrylate can be obtained by, for example, subjecting a hydroxy(meth)acrylate obtained from (meth)acrylic acid or a (meth)acrylate and a polyol to a reaction with a diisocyanate. The urethane (meth)acrylates and oligomers of the urethane (meth)acrylates may be used alone or in combination.

Examples of the (meth)acrylate include methyl (meth)acrylate, ethyl (meth)acrylate, isopropyl (meth)acrylate, butyl (meth)acrylate, and cyclohexyl (meth)acrylate.

Examples of the polyol include ethylene glycol, 1,3-propylene glycol, 1,2-propylene glycol, diethylene glycol, dipropylene glycol, neopentyl glycol, 1,3-butanediol, 1,4-butanediol, 1,6-hexanediol, 1,9-nonanediol, 1,10-decanediol, 2,2,4-trimethyl-1,3-pentanediol, 3-methyl-1,5-pentanediol, neopentyl glycol hydroxypivalate, tricyclodecanedimethylol, 1,4-cyclohexanediol, spiroglycol, tricyclodecanedimethylol, hydrogenated bisphenol A, a bisphenol A-ethylene oxide adduct, a bisphenol A-propylene oxide adduct, trimethylolethane, trimethylolpropane, glycerin, 3-methylpentane-1,3,5-triol, pentaerythritol, dipentaerythritol, tripentaerythritol, and glucoses.

For example, various kinds of aromatic, aliphatic, and alicyclic diisocyanates can be used as the diisocyanate. Specific examples of the diisocyanate include tetramethylene diisocyanate, hexamethylene diisocyanate, isophorone diisocyanate, 2,4-tolylene diisocyanate, 4,4-diphenyl diisocyanate, 1,5-naphthalene diisocyanate, 3,3-dimethyl-4,4-diphenyl diisocyanate, xylene diisocyanate, trimethylhexamethylene diisocyanate, 4,4-diphenylmethane diisocyanate, and hydrogenated products thereof.

The total content of the urethane (meth)acrylate and the oligomer of the urethane (meth)acrylate is preferably from 5 wt % to 70 wt %, more preferably from 5 wt % to 50 wt %, particularly preferably from 5 wt % to 30 wt % with respect to the total amount of the monomer, oligomer, and prepolymer in the composition for forming a hard coat layer. As long as the total content falls within such range, a hard coat layer excellent in balance among hardness, flexibility, and adhesiveness can be formed.

The composition for forming a hard coat layer may contain a (meth)acrylic prepolymer having a hydroxyl group. When the composition for forming a hard coat layer contains the (meth)acrylic prepolymer having a hydroxyl group, the shrinkage on curing of the hard coat layer can be reduced. The (meth)acrylic prepolymer having a hydroxyl group is preferably a polymer obtained by polymerization of a hydroxyalkyl (meth)acrylate having a linear or branched alkyl group having 1 to 10 carbon atoms. As the (meth)acrylic prepolymer having a hydroxyl group, there is given, for example, a polymer obtained by polymerization of at least one monomer selected from the group consisting of 2-hydroxyethyl (meth)acrylate, 2,3-dihydroxypropyl (meth)acrylate, 2-hydroxy-3-acryloyloxypropyl (meth)acrylate, and 2-acryloyloxy-3-hydroxypropyl (meth)acrylate. The (meth)acrylic prepolymers each having a hydroxyl group may be used alone or in combination.

The content of the (meth)acrylic prepolymer having a hydroxyl group is preferably from 5 wt % to 50 wt %, more preferably from 10 wt % to 30 wt % with respect to the total amount of the monomer, oligomer, and prepolymer in the composition for forming a hard coat layer. As long as the content falls within such range, a composition for forming a hard coat layer excellent in applicability is obtained. In addition, the shrinkage on curing of the formed hard coat layer can be effectively prevented.

The composition for forming a hard coat layer preferably contains any appropriate photopolymerization initiator. Examples of the photopolymerization initiator include 2,2-dimethoxy-2-phenylacetophenone, acetophenone, benzophenone, xanthone, 3-methylacetophenone, 4-chlorobenzophenone, 4,4′-dimethoxybenzophenone, benzoin propyl ether, benzyl dimethyl ketal, N,N,N′,N′-tetramethyl-4,4′-diaminobenzophenone, 1-(4-isopropylphenyl)-2-hydroxy-2-methylpropan-1-one, and a thioxanthone-based compound.

The composition for forming a hard coat layer may or may not contain a solvent. Examples of the solvent include dibutyl ether, dimethoxymethane, methyl acetate, ethyl acetate, isobutyl acetate, methyl propionate, ethyl propionate, methanol, ethanol, and methyl isobutyl ketone (MIBK). Those solvents may be used alone or in combination.

The composition for forming a hard coat layer can further contain any appropriate additive. Examples of the additive include a leveling agent, an antiblocking agent, a dispersion stabilizer, a thixotropic agent, an antioxidant, a UV absorber, an antifoaming agent, a thickener, a dispersant, a surfactant, a catalyst, a filler, a lubricant, and an antistatic agent.

As a method of applying the composition for forming a hard coat layer, any appropriate method may be adopted. Examples of the method include a bar coating method, a roll coating method, a gravure coating method, a rod coating method, a slot orifice coating method, a curtain coating method, a fountain coating method, and a comma coating method.

Any appropriate curing treatment can be adopted as a method of curing the composition for forming a hard coat layer. The curing treatment is typically performed by ultraviolet irradiation. The integrated light quantity of the ultraviolet irradiation is preferably from 200 mJ to 400 mJ.

Before the composition for forming a hard coat layer is cured, an applied layer formed of the composition for forming a hard coat layer may be heated. The heating can improve the adhesiveness between the base layer and the hard coat layer. A heating temperature is preferably from 90° C. to 140° C., more preferably from 100° C. to 130° C., still more preferably from 105° C. to 120° C.

C. Adhesive Layer

Any appropriate adhesive can be used as an adhesive constituting the adhesive layer. Specific examples thereof include an acrylic adhesive, a silicone-based adhesive, a styrene-based adhesive, a polyester-based adhesive, a polyurethane-based adhesive, a phenol-based adhesive, and an epoxy-based adhesive. A UV-curable adhesive is preferably used as the adhesive. This is because the adhesive cures without requiring heating and hence can suppress adverse effects on the resin films with hard coat layers.

The thickness of the adhesive layer is preferably from 0.1 μm to 10 μm, more preferably from 0.5 μm to 8 μm.

D. Pressure-Sensitive Adhesive Layer

Any appropriate pressure-sensitive adhesive can be used as a pressure-sensitive adhesive constituting the pressure-sensitive adhesive layer. Specific examples thereof include an acrylic pressure-sensitive adhesive, a silicone-based pressure-sensitive adhesive, a styrene-based pressure-sensitive adhesive, a polyester-based pressure-sensitive adhesive, a polyurethane-based pressure-sensitive adhesive, a phenol-based pressure-sensitive adhesive, and an epoxy-based pressure-sensitive adhesive.

The thickness of the pressure-sensitive adhesive layer is preferably from 15 μm to 50 μm, more preferably from 20 μm to 35 μm.

E. Transparent Conductive Film

According to the present invention, a transparent conductive film can be provided by forming a transparent conductive layer on the laminate. The laminate of the present invention is excellent in dimensional stability, and hence the transparent conductive film obtained by using the laminate can prevent damage to the transparent conductive layer (such as the disconnection of a conductive pattern or an increase in resistance value).

The total light transmittance of the transparent conductive film is preferably 80% or more, more preferably 85% or more, particularly preferably 90% or more. A transparent conductive film having a high total light transmittance can be obtained by providing a transparent conductive layer containing a metal nanowire as described later. In addition, the transparent conductive film of the present invention includes a laminate that includes a base layer having a small retardation and that is excellent in dimensional stability. Accordingly, even when its transmittance is high, i.e., even when the quantity of light to be output from the transparent conductive film is large, a rainbow patch can be suppressed.

The surface resistance value of the transparent conductive film is preferably from 0.1Ω/□ to 1,000Ω/□, more preferably from 0.5Ω/□ to 500Ω/□, particularly preferably from 1Ω/□ to 250Ω/□.

E-1. Transparent Conductive Layer

The transparent conductive layer is constituted of, for example, a metal nanowire, a metal mesh, or a conductive polymer.

When the transparent conductive film is used in an electrode for a touch panel or the like, the transparent conductive layer may be patterned into a predetermined pattern. The shape of the pattern of the transparent conductive layer is not particularly limited as long as the pattern satisfactorily operates as a touch panel (such as a capacitance-type touch panel). Examples thereof include patterns described in JP 2011-511357 A, JP 2010-164938 A, JP 2008-310550 A, JP 2003-511799 A, and JP 2010-541109 A. After having been formed on the laminate, the transparent conductive layer can be patterned by employing a known method.

(Metal Nanowire)

The metal nanowire refers to a conductive substance that uses a metal as a material, has a needle- or thread-like shape, and has a diameter of the order of nanometers. The metal nanowire may be linear or may be curved. When a transparent conductive layer constituted of the metal nanowire is used, the metal nanowire is formed into a network shape. Accordingly, even when a small amount of the metal nanowire is used, a good electrical conduction path can be formed and hence a transparent conductive film having a small electrical resistance can be obtained. Further, the metal nanowire is formed into a network shape, and hence an opening portion is formed in a gap of the network. As a result, a transparent conductive film having a high light transmittance can be obtained.

A ratio (aspect ratio: L/d) between a thickness d and length L of the metal nanowire is preferably from 10 to 100,000, more preferably from 50 to 100,000, particularly preferably from 100 to 10,000. When a metal nanowire having such large aspect ratio as described above is used, the metal nanowire satisfactorily intersects with itself and hence high conductivity can be expressed with a small amount of the metal nanowire. As a result, a transparent conductive film having a high light transmittance can be obtained. It should be noted that the term “thickness of the metal nanowire” as used herein has the following meanings: when a section of the metal nanowire has a circular shape, the term means the diameter of the circle; when the section has an elliptical shape, the term means the short diameter of the ellipse; and when the section has a polygonal shape, the term means the longest diagonal of the polygon. The thickness and length of the metal nanowire can be observed with a scanning electron microscope or a transmission electron microscope.

The thickness of the metal nanowire is preferably less than 500 nm, more preferably less than 200 nm, particularly preferably from 10 nm to 100 nm, most preferably from 10 nm to 50 nm. When the thickness falls within such range, a transparent conductive layer having a high light transmittance can be formed.

The length of the metal nanowire is preferably from 2.5 μm to 1,000 μm, more preferably from 10 μm to 500 μm, particularly preferably from 20 μm to 100 μm. When the length falls within such range, a transparent conductive film having high conductivity can be obtained.

Any appropriate metal can be used as a metal constituting the metal nanowire as long as the metal has high conductivity. Examples of the metal constituting the metal nanowire include silver, gold, copper, and nickel. In addition, a material obtained by subjecting any such metal to a plating treatment (such as a gold plating treatment) may be used. Of those, silver, copper, or gold is preferred from the viewpoint of conductivity, and silver is more preferred.

Any appropriate method can be adopted as a method of producing the metal nanowire. Examples thereof include: a method involving reducing silver nitrate in a solution; and a method involving causing an applied voltage or current to act on a precursor surface from the tip portion of a probe, drawing a metal nanowire at the tip portion of the probe, and continuously forming the metal nanowire. In the method involving reducing silver nitrate in the solution, a silver nanowire can be synthesized by performing the liquid-phase reduction of a silver salt such as silver nitrate in the presence of a polyol such as ethylene glycol and polyvinyl pyrrolidone. The mass production of a silver nanowire having a uniform size can be performed in conformity with a method described in, for example, Xia, Y. et al., Chem. Mater. (2002), 14, 4736-4745 or Xia, Y. et al., Nano letters (2003), 3 (7), 955-960.

The transparent conductive layer can be formed by applying, onto the laminate, a composition for forming a transparent conductive layer containing the metal nanowire. More specifically, the transparent conductive layer can be formed by applying, onto the laminate, a dispersion liquid (composition for forming a transparent conductive layer) obtained by dispersing the metal nanowire in a solvent, and then drying the applied layer.

Examples of the solvent include water, an alcohol-based solvent, a ketone-based solvent, an ether-based solvent, a hydrocarbon-based solvent, and an aromatic solvent. Water is preferably used from the viewpoint of reduction in environmental load.

The dispersion concentration of the metal nanowire in the composition for forming a transparent conductive layer containing the metal nanowire is preferably from 0.1 wt % to 1 wt %. When the dispersion concentration falls within such range, a transparent conductive layer excellent in conductivity and light transmittance can be formed.

The composition for forming a transparent conductive layer containing the metal nanowire may further contain any appropriate additive depending on purposes. Examples of the additive include an anticorrosive material for preventing the corrosion of the metal nanowire and a surfactant for preventing the agglomeration of the metal nanowire. The kinds, number, and amount of additives to be used can be appropriately set depending on purposes. In addition, the composition for forming a transparent conductive layer may contain any appropriate binder resin as required as long as the effects of the present invention are obtained.

Any appropriate method may be adopted as an application method for the composition for forming a transparent conductive layer containing the metal nanowire. Examples of the application method include spray coating, bar coating, roll coating, die coating, inkjet coating, screen coating, dip coating, a relief printing method, an intaglio printing method, and a gravure printing method. Any appropriate drying method (such as natural drying, blast drying, or heat drying) can be adopted as a method of drying the applied layer. In the case of, for example, the heat drying, a drying temperature is typically from 100° C. to 200° C. and a drying time is typically from 1 to 10 minutes.

When the transparent conductive layer is constituted of the metal nanowire, the thickness of the transparent conductive layer is preferably from 0.01 μm to 10 μm, more preferably from 0.05 μm to 3 μm, particularly preferably from 0.1 μm to 1 μm. When the thickness falls within such range, a transparent conductive film excellent in conductivity and light transmittance can be obtained.

When the transparent conductive layer is constituted of the metal nanowire, the total light transmittance of the transparent conductive layer is preferably 85% or more, more preferably 90% or more, still more preferably 95% or more.

The content of the metal nanowire in the transparent conductive layer is preferably from 80 wt % to 100 wt %, more preferably from 85 wt % to 99 wt % with respect to the total weight of the transparent conductive layer. When the content falls within such range, a transparent conductive film excellent in conductivity and light transmittance can be obtained.

When the metal nanowire is a silver nanowire, the density of the transparent conductive layer is preferably from 1.3 g/cm³ to 10.5 g/cm³, more preferably from 1.5 g/cm³ to 3.0 g/cm³. When the density falls within such range, a transparent conductive film excellent in conductivity and light transmittance can be obtained.

(Metal Mesh)

The transparent conductive layer constituted of the metal mesh is obtained by forming a thin metal wire into a lattice pattern on the laminate. The transparent conductive layer constituted of the metal mesh can be formed by any appropriate method. The transparent conductive layer can be obtained by, for example, applying a photosensitive composition containing a silver salt onto the laminate, and then subjecting the resultant to an exposure treatment and a developing treatment to form the thin metal wire into a predetermined pattern. In addition, the transparent conductive layer can be obtained by printing a paste containing metal fine particles into a predetermined pattern. Details about such transparent conductive layer and a formation method therefor are described in, for example, JP 2012-18634 A, and the description is incorporated herein by reference. In addition, other examples of the transparent conductive layer constituted of the metal mesh and the formation method therefor are a transparent conductive layer and formation method therefor described in JP 2003-331654 A.

When the transparent conductive layer is constituted of the metal mesh, the thickness of the transparent conductive layer is preferably from 0.1 μm to 30 μm, more preferably from 0.1 μm to 9 μm, still more preferably from 1 μm to 3 μm.

When the transparent conductive layer is constituted of the metal mesh, the transmittance of the transparent conductive layer is preferably 80% or more, more preferably 85% or more, still more preferably 90% or more.

(Conductive Polymer)

The transparent conductive layer constituted of the conductive polymer can be formed by applying, onto the laminate, a conductive composition containing the conductive polymer.

Examples of the conductive polymer include a polyacetylene-based polymer, a polythiophene-based polymer, a polyphenylene-based polymer, a polypyrrole-based polymer, a polyaniline-based polymer, and a polyester-based polymer modified with an acrylic polymer. Those conductive polymers may be used alone or in combination.

A polythiophene-based polymer is preferably used as the conductive polymer. A transparent conductive layer excellent in transparency and chemical stability can be formed by using the polythiophene-based polymer. Specific examples of the polythiophene-based polymer include: polythiophene; a poly(3-C₁₋₈ alkyl-thiophene) such as poly(3-hexylthiophene); a poly(3,4-(cyclo)alkylenedioxythiophene) such as poly(3,4-ethylenedioxythiophene), poly(3,4-propylenedioxythiophene), or poly[3,4-(1,2-cyclohexylene)dioxythiophene]; and polythienylene vinylene.

The conductive polymer is preferably polymerized in the presence of an anionic polymer. For example, the polythiophene-based polymer is preferably oxidation-polymerized in the presence of the anionic polymer. Examples of the anionic polymer include polymers each having a carboxyl group, a sulfonic group, and/or a salt thereof. An anionic polymer having a sulfonic group such as polystyrene sulfonic acid is preferably used.

The conductive polymer, the transparent conductive layer constituted of the conductive polymer, and a method of forming the transparent conductive layer are described in, for example, JP 2011-175601 A, and the description is incorporated herein by reference.

When the transparent conductive layer is constituted of the conductive polymer, the thickness of the transparent conductive layer is preferably from 0.01 μm to 1 μm, more preferably from 0.01 μm to 0.5 μm, still more preferably from 0.03 μm to 0.3 lam.

When the transparent conductive layer is constituted of the conductive polymer, the transmittance of the transparent conductive layer is preferably 80% or more, more preferably 85% or more, still more preferably 90% or more.

E-2. Other Layer

The transparent conductive film may include any appropriate other layer as required. Examples of the other layer include an antistatic layer, an antiglare layer, an antireflection layer, and a color filter layer.

E-3. Application

The transparent conductive film can be used in an electronic device such as a display element. More specifically, the transparent conductive film can be used as, for example, an electrode to be used in a touch panel or the like, or an electromagnetic wave shield for blocking an electromagnetic wave responsible for the malfunction of an electronic device.

### EXAMPLES

Hereinafter, the present invention is specifically described by way of Examples but the present invention is not limited by Examples described below. Evaluation methods in Examples are as described below. It should be noted that a thickness was measured with a Peacock Precision Measuring Instrument Digital Gauge Cordless Type “DG-205” manufactured by Ozaki Mfg Co., Ltd.

### (1) Dimensional Stability 1

The resultant laminate (100 mm×100 mm) was placed under 120° C. for 90 minutes, and the dimensional change ratio (area shrinkage ratio) of the laminate was measured with a large CNC image measuring machine manufactured by Mitutoyo Corporation (trade name: QV ACCEL 808).

### (2) Dimensional Stability 2

The resultant laminate (100 mm×100 mm) was immersed in warm water at 85° C. for 30 minutes, and the dimensional change ratio (area shrinkage ratio) of the laminate was measured with a large CNC image measuring machine manufactured by Mitutoyo Corporation (trade name: QV ACCEL 808).

### (3) Total Light Transmittance

The total light transmittance of the resultant laminate was measured with an instrument available under the trade name “HR-100” from Murakami Color Research Laboratory Co., Ltd. at room temperature. The measurement was repeated three times and the average of the three measured values was defined as a measured value.

### (4) Curling of Laminate

The laminate (100 mm×100 mm) that has already been subjected to the evaluations (1) and (2) is left at rest on a horizontal table. Then, the floating heights (mm) of the four corners of the test piece from the table are measured. At this time, when the central portion of the test piece is floating, the measurement is performed in a state where the test piece is inverted and the measured values are regarded as negative values. The average of the measured values of the four corners was defined as a curling value, and the case where the absolute value of the curling value was from 0 to 10 mm was evaluated as ∘, the case where the absolute value was from 10 to 30 mm was evaluated as Δ, and the case where the absolute value was 30 mm or more, or the test piece was of a tubular shape and hence the four corners could not be subjected to the measurement was evaluated as x.

### (5) Surface Resistance

The surface resistance of the resultant conductive film was measured with a non-contact resistance meter manufactured by Napson Corporation (trade name: EC-80). The measurement was performed at 23° C.

### Production Example 1

### Production of Laminate

### (Production of Base Layer)

100 Parts by weight of an imidized MS resin described in Production Example 1 of JP 2010-284840 A and 0.62 part by weight of a triazine-based UV absorber (manufactured by Adeka Corporation, trade name: T-712) were mixed with a biaxial kneader at 220° C. to produce a resin pellet. The resultant resin pellet was dried at 100.5 kPa and 100° C. for 12 hours, and was then extruded from the T-die of a uniaxial extruder at a die temperature of 270° C. to be formed into a film shape (having a thickness of 160 μm). Further, the film was stretched in its conveyance direction under an atmosphere at 150° C. (to have a thickness of 80 μm). Next, the film was stretched in a direction perpendicular to the film conveyance direction under an atmosphere at 150° C. to provide a base layer ((meth)acrylic resin film) having a thickness of 40 μm. The base layer had an in-plane retardation Re of 0.4 nm and a thickness direction retardation Rth of 0.78 nm. The retardation values were each measured with a product available under the trade name “KOBRA21-ADH” from Oji Scientific Instruments at a wavelength of 590 nm and 23° C.

(Preparation of Composition for Forming Hard Coat Layer)

100 Parts of a UV-curable resin (manufactured by DIC Corporation, trade name: PC1070, solid content: 66%, solvents: ethyl acetate and butyl acetate) containing a urethane acrylate obtained from a pentaerythritol-based acrylate and a hydrogenated xylene diisocyanate, dipentaerythritol hexaacrylate, pentaerythritol triacrylate, pentaerythritol tetraacrylate, a (meth)acrylic polymer having a 2-hydroxyethyl group and a 2,3-dihydroxypropyl group, and photoreaction initiators (manufactured by Ciba Japan, trade name: IRGACURE 184; manufactured by BASF, trade name: Lucirin TPO), 15 parts of pentaerythritol triacrylate (PETA) (manufactured by Osaka Organic Chemical Industry Ltd., trade name: Viscoat #300), 15 parts of 4-hydroxybutyl acrylate (4-HBA) (manufactured by Osaka Organic Chemical Industry Ltd.), 5 parts of a leveling agent (manufactured by DIC Corporation, trade name: GRANDIC PC-4100), and 3 parts of a photopolymerization initiator (manufactured by Ciba Japan, trade name: IRGACURE 907) were mixed, and then the mixture was diluted with methyl isobutyl ketone so that a solid content became 50%. Thus, a composition for forming a hard coat layer was prepared. It should be noted that the composition of the UV-curable resin (PC1070) is as described below.

| | |
|---|---|
| Urethane acrylate obtained from a pentaerythritol-based | 100 parts |
| acrylate and a hydrogenated xylene diisocyanate | |
| Dipentaerythritol hexaacrylate | 49 parts |
| Pentaerythritol tetraacrylate | 41 parts |
| Pentaerythritol triacrylate | 24 parts |
| (Meth)acrylic polymer having a 2-hydroxyethyl group and a | 58 parts |
| 2,3-dihydroxypropyl group | |

(Production of Resin Film with Hard Coat Layer)

An applied layer was formed by applying the composition for forming a hard coat layer onto the base layer, and the applied layer was heated at 90° C. for 1 minute. The applied layer after the heating was cured by irradiating the applied layer with UV light having an integrated light quantity of 300 mJ/cm² from a high-pressure mercury lamp. Thus, a resin film with a hard coat layer having the base layer (thickness: 40 μm) and a hard coat layer (thickness: 5 μm) was produced.

### Example 1

Two resin films with hard coat layers obtained in Production Example 1 were prepared. The base layers of the resin films with hard coat layers were bonded to each other through a pressure-sensitive adhesive. Thus, a laminate (hard coat layer/base layer/pressure-sensitive adhesive layer (thickness: 20 μm)/base layer/hard coat layer) was produced.

The pressure-sensitive adhesive used was a transparent pressure-sensitive adhesive having an elastic coefficient of 10 N/cm², the pressure-sensitive adhesive being obtained by compounding 100 parts of an acrylic copolymer containing butyl acrylate, acrylic acid, and vinyl acetate at a weight ratio of 100:2:5 with 1 part of an isocyanate-based cross-linking agent.

The resultant laminate was subjected to the evaluations (1) to (4). Table 1 shows the results.

### Example 2

Two resin films with hard coat layers obtained in Production Example 1 were prepared. The hard coat layers of the resin films with hard coat layers were bonded to each other through the same pressure-sensitive adhesive as that of Example 1. Thus, a laminate (base layer/hard coat layer/pressure-sensitive adhesive layer (thickness: 20 μm)/hard coat layer/base layer) was produced.

The resultant laminate was subjected to the evaluations (1) to (4). Table 1 shows the results.

### Example 3

Two resin films with hard coat layers obtained in Production Example 1 were prepared. The base layer of one of the resin films with hard coat layers and the hard coat layer of the other resin film with a hard coat layer were bonded to each other through the same pressure-sensitive adhesive as that of Example 1. Thus, a laminate (base layer/hard coat layer/pressure-sensitive adhesive layer (thickness: 20 μm)/base layer/hard coat layer) was produced.

The resultant laminate was subjected to the evaluations (1) to (4). Table 1 shows the results.

### Comparative Example 1

The base layers produced in Production Example 1 were bonded to each other through the same pressure-sensitive adhesive as that of Example 1. Thus, a laminate (base layer/pressure-sensitive adhesive layer (thickness: 20 μm)/base layer) was produced.

The resultant laminate was subjected to the evaluations (1) to (4). Table 1 shows the results.

### Comparative Example 2

The resin film with a hard coat layer (base layer/hard coat layer) produced in Production Example 1 was subjected to the evaluations (1) to (4). Table 1 shows the results.

TABLE 1

| | Total light | 120° C. | | Warm water at 85° C. | |
|---|---|---|---|---|---|
| | trans- | Dimensional | | Dimensional | |
| | mittance | stability 1 | Curling | stability 2 | Curling |
| Example 1 | 91.8% | 1.1% | ∘ | 0.6% | ∘ |
| Example 2 | 91.8% | 1.2% | ∘ | 0.5% | ∘ |
| Example 3 | 91.7% | 1.4% | Δ | 0.6% | Δ |
| Comparative | 92.1% | 41.4% | ∘ | 3.8% | ∘ |
| Example 1 | | | | | |
| Comparative | 92.0% | 7.5% | Δ | Unmeas- | x |
| Example 2 | | | | urable | |

### Production Example 2

### Synthesis of Metal Nanowire and Preparation of Composition for Forming Transparent Conductive Layer

5 Milliliters of anhydrous ethylene glycol and 0.5 ml of a solution of PtCl₂ in anhydrous ethylene glycol (concentration: 1.5×10⁻⁴ mol/L) were added to a reaction vessel equipped with a stirring apparatus under 160° C. After a lapse of 4 minutes, 2.5 ml of a solution of AgNO₃ in anhydrous ethylene glycol (concentration: 0.12 mol/l) and 5 ml of a solution of polyvinyl pyrrolidone (MW: 5,500) in anhydrous ethylene glycol (concentration: 0.36 mol/l) were simultaneously dropped to the resultant solution over 6 minutes to produce a silver nanowire. The dropping was performed under 160° C. until AgNO₃ was completely reduced. Next, acetone was added to the reaction mixture containing the silver nanowire obtained as described above until the volume of the reaction mixture became 5 times as large as that before the addition. After that, the reaction mixture was centrifuged (2,000 rpm, 20 minutes). Thus, a silver nanowire was obtained.

The resultant silver nanowire had a short diameter of from 30 nm to 40 nm, a long diameter of from 30 nm to 50 nm, and a length of from 20 μm to 50 μm.

The silver nanowire (concentration: 0.2 wt %) and dodecyl-pentaethylene glycol (concentration: 0.1 wt %) were dispersed in pure water to prepare a composition for forming a transparent conductive layer.

### Example 4

The composition for forming a transparent conductive layer prepared in Production Example 2 was applied onto the laminate produced in Example 1 with a bar coater (manufactured by Dai-ichi Rika Co., Ltd., product name: “Bar Coater No. 10”). After that, the composition was dried in a fan dryer at 120° C. for 2 minutes. Thus, a transparent conductive film having a transparent conductive layer (thickness: 0.1 μm) formed on the laminate was obtained. No remarkable heat shrinkage occurred at the time of the drying. In addition, the surface resistance value of the resultant transparent conductive film was 43.7Ω/□.

### Example 5

A transparent conductive film was produced by the same method as that of Example 4 except that a PEDOT/PSS dispersion liquid (manufactured by Heraeus Holding GmbH, trade name: “Clevios FE-T”; dispersion liquid of a conductive polymer constituted of polyethylene dioxythiophene and polystyrene sulfonic acid) was used as a composition for forming a transparent conductive layer. No remarkable heat shrinkage occurred at the time of the drying. In addition, the surface resistance value of the resultant transparent conductive film was 93.2Ω/□.

### Example 6

A metal mesh (line width: 100 μm) was formed on the laminate produced in Example 1 by using a silver paste (manufactured by Toyochem Co., Ltd., trade name: “RA FS 039”) by a screen printing method, and was sintered at 120° C. for 10 minutes. No remarkable heat shrinkage occurred at the time of the drying. In addition, the surface resistance value of the resultant transparent conductive film was 19.1Ω/□.

### INDUSTRIAL APPLICABILITY

The laminate of the present invention can be suitably used as a base material for a transparent conductive film. The transparent conductive film can be used in an electronic device such as a display element. More specifically, the transparent conductive film can be used as, for example, an electrode to be used in a touch panel or the like, or an electromagnetic wave shield.

### REFERENCE SIGNS LIST

1 base layer
2 hard coat layer
10 resin film with hard coat layer
20 adhesive layer

1. A laminate, comprising a plurality of resin films with hard coat layers, which are laminated together, the plurality of resin films with hard coat layers each including a base layer containing a thermoplastic resin and a hard coat layer containing a curable resin, the hard coat layer being formed on the base layer.

2. A laminate according to claim 1, wherein the laminate has a lamination construction vertically symmetric with respect to a center line in a thickness direction thereof.

3. A laminate according to claim 1, wherein a number of the resin films with hard coat layers is two.

4. A laminate according to claim 1, wherein the plurality of resin films with hard coat layers are bonded to each other through an adhesive layer or a pressure-sensitive adhesive layer.

5. A laminate according to claim 2, wherein the respective base layers of the two resin films with hard coat layers are bonded to each other through the adhesive layer or the pressure-sensitive adhesive layer.

6. A laminate according to claim 2, wherein the respective hard coat layers of the two resin films with hard coat layers are bonded to each other through the adhesive layer or the pressure-sensitive adhesive layer.

7. A laminate according to claim 3, wherein:
the laminate comprises the two resin films with hard coat layers; and
the base layer of one of the resin films with hard coat layers and the hard coat layer of another of the resin films with hard coat layers are bonded to each other through the adhesive layer or the pressure-sensitive adhesive layer.

8. A laminate according to claim 1, wherein the laminate has a total light transmittance of 80% or more.

9. A laminate according to claim 1, wherein the thermoplastic resin in the base layer comprises a (meth)acrylic resin.

10. A transparent conductive film, comprising:
the laminate of claim 1; and
a transparent conductive layer formed on the laminate.

11. A transparent conductive film according to claim 10, wherein the transparent conductive layer contains a metal nanowire.

12. A transparent conductive film according to claim 10, wherein the transparent conductive layer contains a metal mesh.

13. A transparent conductive film according to claim 10, wherein the transparent conductive layer contains a polythiophene-based polymer.
